(19) United States
(12) Patent Application Publication
(10) Pub. No.: US 2007/0044400 A1
(43) Pub. Date: Mar. 1, 2007

(54) Wood trim system and method of making same

(76) Inventors: Matthew Robert Bunner, White Pigeon, MI (US); Elaine Joyce Ryan, Elkhart, IN (US); Jan Oostland, Goshen, IN (US); Todd Robert Townsend, South Bend, IN (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/215,177

(22) Filed: Aug. 30, 2005

(51) Int. Cl. E06B 1/04

(52) U.S. Cl. 52/211

(57) ABSTRACT

A trim frame assembly includes a first trim member, a first end member, and a second end member. The first end member has a first side facing the first end of the first trim member and a second side opposite the first side, with the first side having a recess formed therein that extends into the first end member through the first side but terminates before reaching the second side. The recess has a perimeter edge, which has a shape that generally follows the profile of the trim member wherein the trim member is insertable into the recess. The second end member similarly has a first side facing the second end of the first trim member and a second side opposite the first side, with the first side of the second end member having a recess formed therein, which extends into the second end member through the first side of the second end member but terminates before reaching the second side of the second end member. This recess also has a perimeter edge with a shape that generally follows the profile of the trim member wherein the trim member is insertable into the recess of the second end member.

### TECHNICAL FIELD AND BACKGROUND OF THE INVENTION

The present invention relates to wood trim components and, more particularly, to various wood trim components that can be assembled in various combinations to form various wood trim assemblies or systems.

### SUMMARY OF THE INVENTION

The present invention provides a simplified trim assembly and method of making the trim assembly by reducing the amount of precision cut trim pieces to form the trim assembly.

In one aspect of the invention, a trim frame assembly includes a first trim member, a first end member, and a second end member. The first trim member has an outer facing surface with a profile, a first end, and a second end opposed from the first end. The first end member has a first side facing the first end of the first trim member and a second side opposite the first side. The first side of the first end member has a recess formed therein, which extends into the first end member through the first side but terminates before reaching the second side. The recess has a perimeter edge that has a shape generally following the profile of the trim member wherein the trim member is insertable into the recess through the first side of the first end member. The second end member has a first side facing the second end of the first trim member and a second side opposite the first side. The first side of the second end member also has a recess formed therein, which extends into the second end member through the first side of the second end member but terminates before reaching the second side of the second end member. This recess also has a perimeter edge that has a shape generally following the profile of the trim member wherein the trim member is insertable into the recess of the second end member.

In one aspect, the trim member comprises at least two trim pieces.

In another aspect, the recess of the first end member and/or the second end member extends to at least one edge of the first end member and/or the second end member.

In further aspects, the trim frame assembly further includes a second trim member and a third end member. The second trim member has opposed first and second ends and an outer facing surface. The second trim member is mounted between the second side of the first end member and the third end member.

Optionally, the trim frame assembly may further include a third trim member and a fourth end member, with the third trim member having opposed first and second ends and an outer facing surface. The third trim member is mounted between the second side of the second end member and the fourth end member.

Additionally, the trim frame assembly may include a fourth trim member having opposed first and second ends. The first end of the fourth trim member extending between the first and third end members wherein the second trim member overlaps with the first end of the fourth trim member. In a further aspect, the fourth trim member includes an outer facing surface with a profile, and the second trim member includes an edge having a contour generally following the profile of the fourth trim member where the second trim member overlaps with the fourth trim member.

According to yet a further aspect, the trim frame assembly may include a fifth trim member, with opposed first and second ends and an outer facing surface. The first end of the fifth trim member extends between the second and fourth end members wherein the third trim member overlaps with the first end of the fifth trim member. Similarly, the third trim member includes an edge having a contour generally following the profile of the fifth trim member where the third trim member overlaps with the fifth trim member.

In any of these combinations, the trim members may comprise two or more trim pieces. For example, at least one of the trim members may comprise a first trim piece and a second trim piece, with the first trim piece having a recess and the second trim piece nesting in the recess of the first trim piece.

According to another form of the invention, a trim assembly includes a first trim member, a first end member, a second end member, and a second trim member. The first trim member is mounted between the first and second ends. The second trim member has opposed first and second ends and an outer facing surface with a profile. The first end of the second trim member extends between the first and second end members behind the first trim member so that the first trim member overlaps first end of the second trim member. The first trim member has an edge with a contour that generally follows the profile of the second trim member where the first trim member overlaps with the second trim member.

In one aspect, the trim assembly forms a column trim assembly.

In another aspect, the trim assembly further includes a third trim member, with opposed first and second ends and an outer facing surface with a profile. The first end member includes a recess in its second side, with the first end of the third trim extending into the second side of the first end member in the recess. The recess has a perimeter edge with a contour generally following the profile of the third trim member.

In a further aspect, the trim assembly further includes a third end member, with a first side facing the second end of the third trim member and a second side. The first side of the third end member has a recess, which has a perimeter edge with a contour generally following the profile of the third trim member. The second end of the third trim member extends into the recess of the third end member.

In any of the preceding combinations, one or more of the members may be formed from wood, wood composite, wood laminate, or a molded material such as MDF. In addition, in any one of the preceding combinations, the end members may comprise a plate member. Further, any of the trim members may be formed from one or more trim pieces.

In accordance with another form of the invention, a trim assembly is formed by providing a first end member with a first side of a second side, providing a trim member with first and second opposed ends and an outer facing surface having a profile, and forming a recess in the first side of the first end member, which includes shaping a perimeter edge of the recess to generally follow the profile of the trim members. In addition, a second end member with first and second sides is provided and a second recess is formed in the first side of the second end member. The perimeter of the second recess is shaped to generally follow the profile of the trim member. The trim member is then positioned in the recesses of the first and second end members to thereby form the trim assembly.

In one aspect, the trim member is provided by first and second trim pieces. For example, a recess may be formed in the first trim piece, with the second trim piece placed in the recess of the first trim piece to thereby form the trim member.

In other aspects, third and fourth end members are provided, each with a first side and a second side. Second and third trim members are also provided, with the second trim member mounted between the first end member and a third end member and the third trim member mounted between the second end member and the fourth end member.

In yet a further aspect, a fourth trim member is provided, with the end of fourth trim member positioned between the first and third end members. The second trim member is overlapped with the fourth trim member wherein the fourth trim member extends behind the second trim member between the first and third end members.

Additionally, a fifth trim member may be provided and positioned between the second and fourth end members. The third trim member is then overlapped with an end of the fifth trim member wherein the fifth trim member extends behind the third trim member between the second and fourth end members.

Optionally, the lower edge of the second trim member is shaped so that it generally follows a contour of an outer facing surface of the fourth trim member where the second trim member overlaps with the fourth trim member.

Similarly, the lower edge of the third trim member may be shaped to generally follow a profile of an outer facing surface of the fifth trim member.

Accordingly, the present invention provides a simplified trim assembly that is easier to assemble and install by eliminating at least some of the precision cutting required with conventional trim work while still providing precision joinery. Further, given the modular nature of the trim components, the trim components can be combined in numerous different ways to create customized trim work at a significantly reduced cost over conventional trim work.

These and other objects, advantages, purposes, and features of the invention will become more apparent from the study of the following description taken in conjunction with the drawings.

### DETAILED DESCRIPTION OF THE DRAWINGS

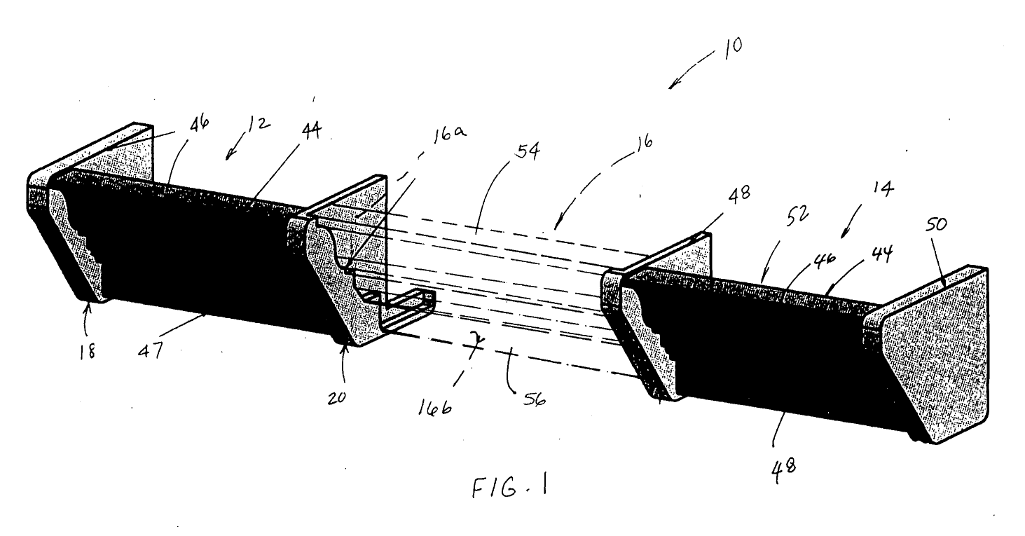

FIG. 1 is a perspective view of a first embodiment of a wood trim assembly of the present invention;

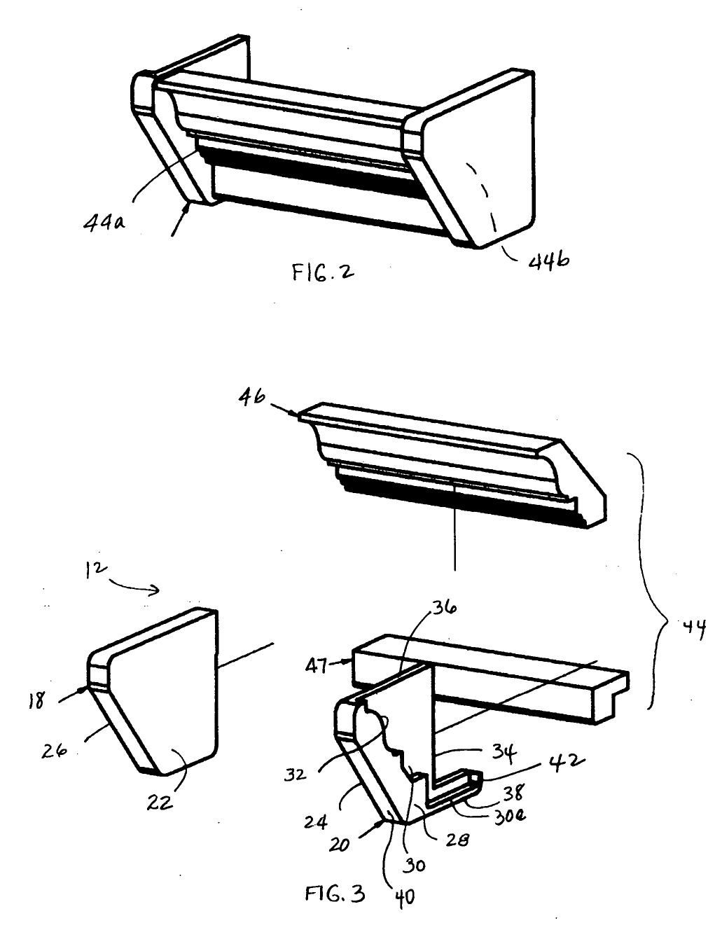

FIG. 2 is a perspective view of a right-hand corner block of the trim assembly of FIG. 1;

FIG. 3 is an exploded perspective view of the left-hand corner block of a trim assembly of FIG. 1;

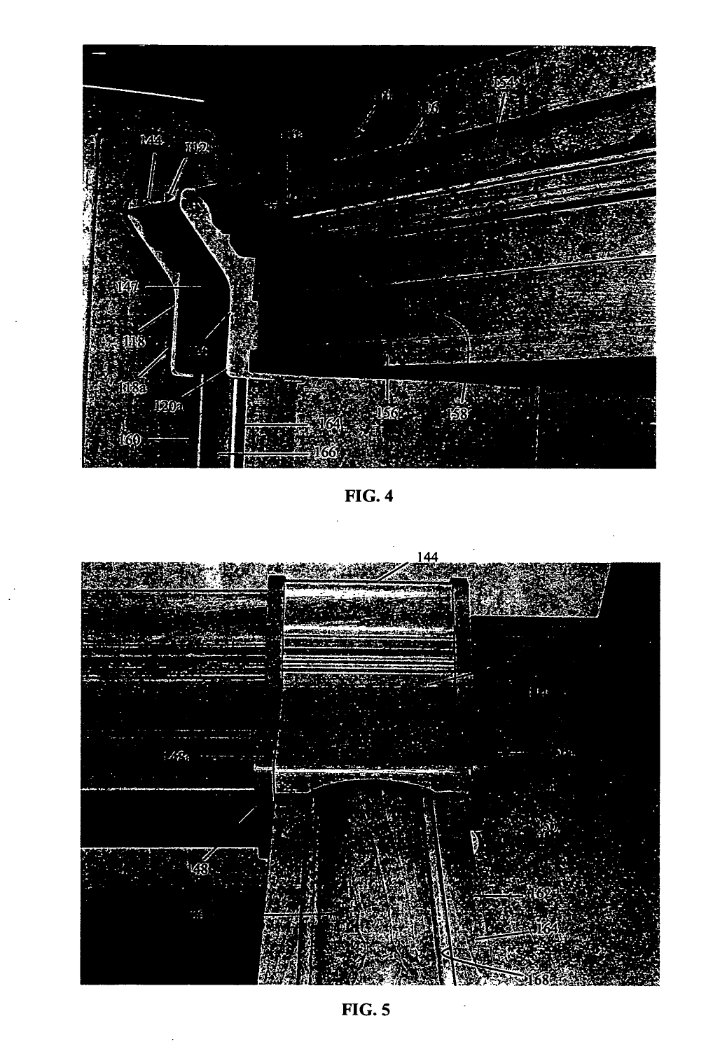

FIG. 4 is a photograph of another embodiment of a trim assembly of the present invention incorporating a column that extends into the left-hand corner block of the trim assembly;

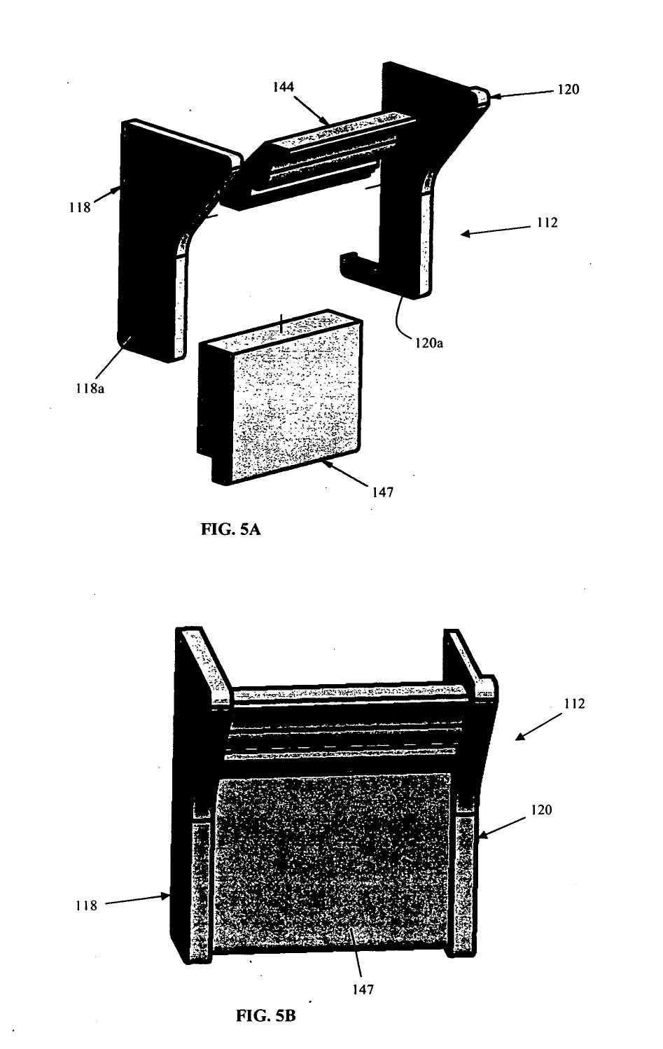

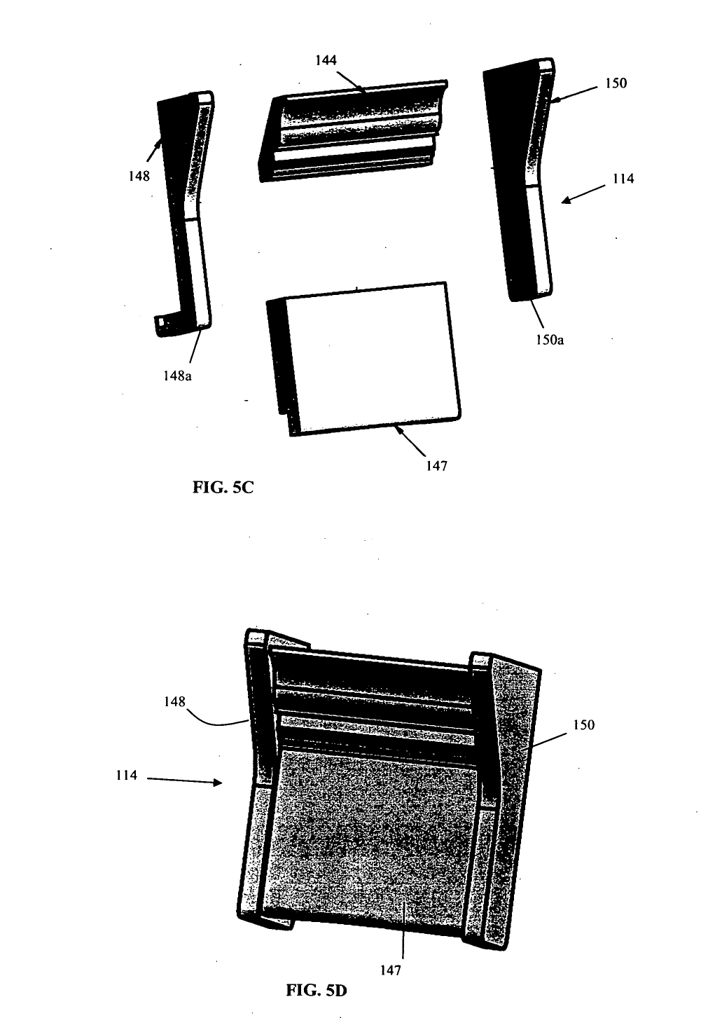

FIG. 5 is an enlarged detailed view of the column trim member extending into a right-hand corner block of the trim assembly of FIG. 4;

FIG. 5A is an enlarged perspective view of the left-hand corner block of the trim assembly of FIG. 1;

FIG. 5B is an exploded perspective view of the corner block of FIG. 5A;

FIG. 5C is an enlarged perspective view of the right-hand corner block of the trim assembly of FIG. 5;

FIG. 5D is an exploded perspective view of the corner block of FIG. 5C;

FIG. 5E is a perspective view of a splice block of the present invention;

FIG. 5F is an exploded perspective view of the splice block of FIG. 5E;

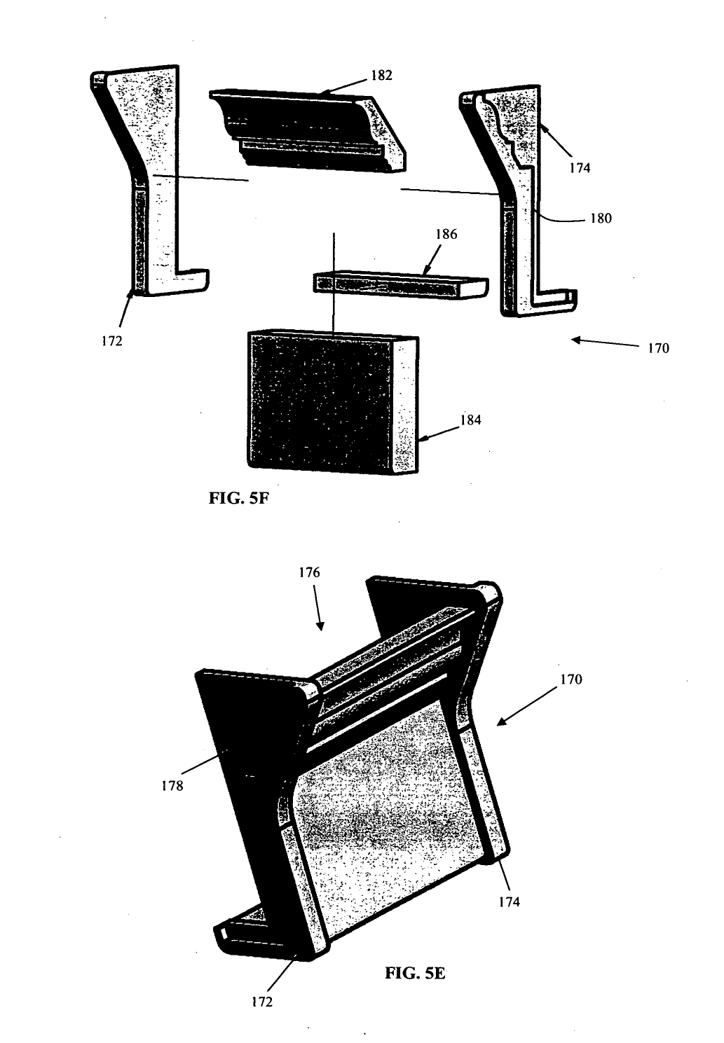

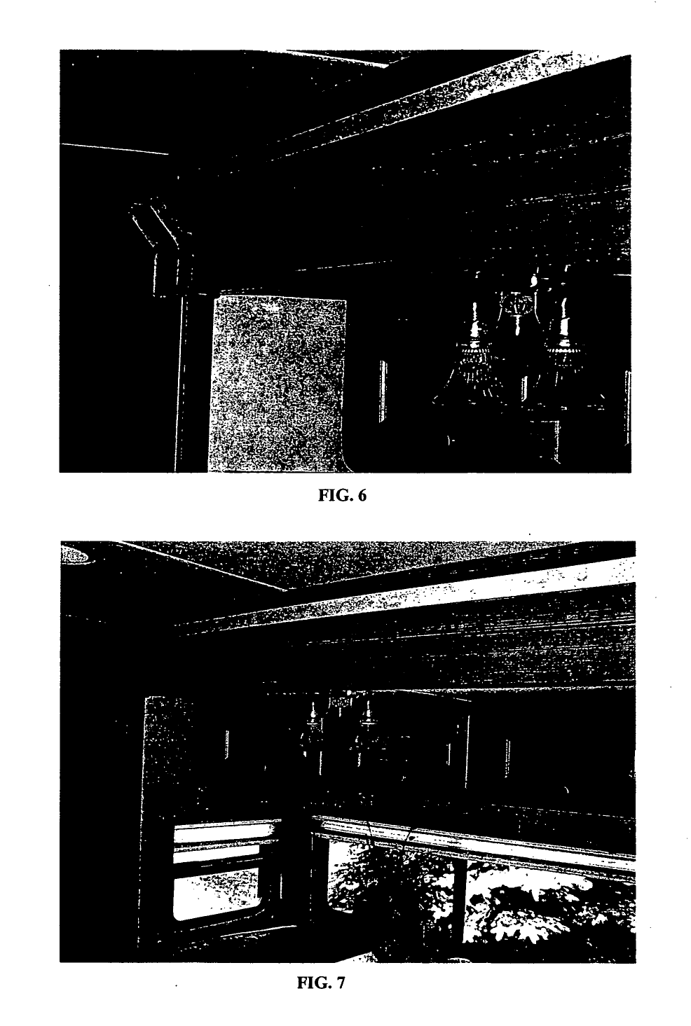

FIG. 6 is a similar view to FIG. 4 illustrating the trim assembly formed from a different wood;

FIG. 7 is a similar view to FIG. 6 of the trim assembly;

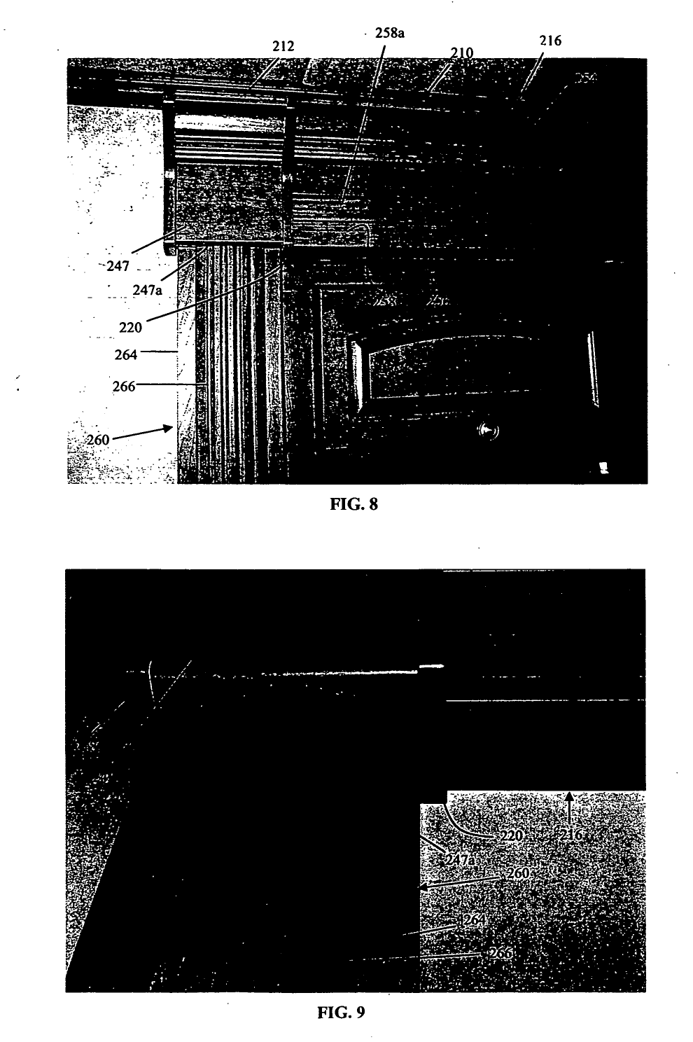

FIG. 8 is a perspective view of another embodiment of the trim assembly of the present invention;

FIG. 9 is an enlarged bottom perspective view of the left-hand corner block of the trim assembly in FIG. 8 illustrating the column trim member of the trim assembly inserting into the left-hand corner block;

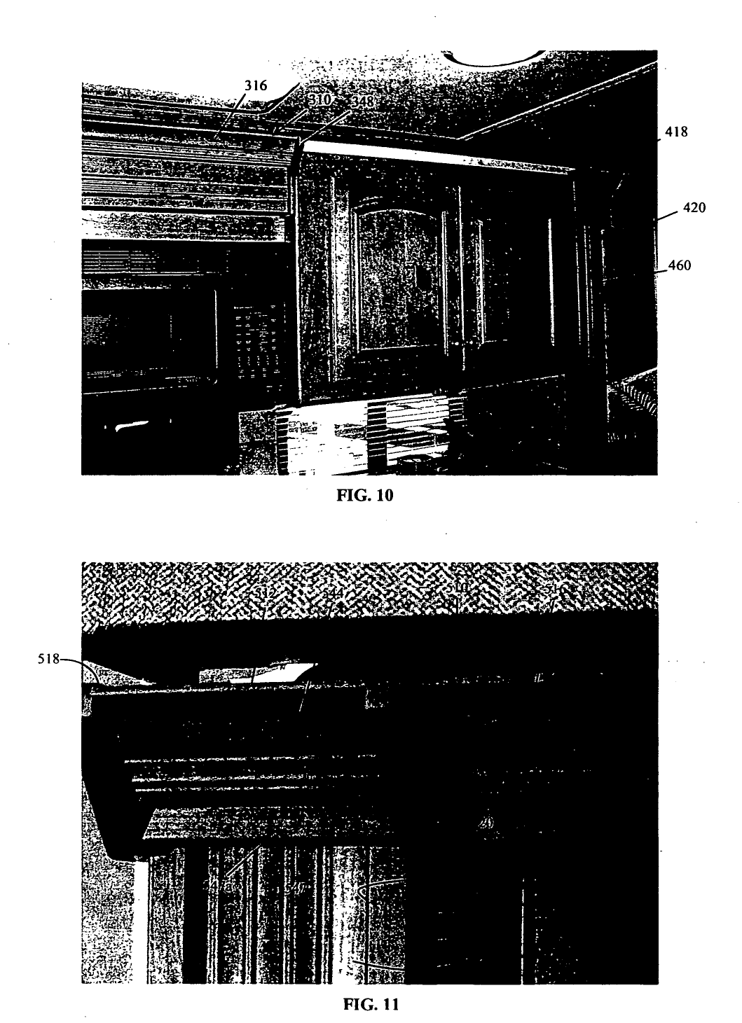

FIG. 10 is a perspective view of two other embodiments of the trim assembly of the present invention;

FIG. 11 is a perspective view of another embodiment of the trim assembly of the present invention;

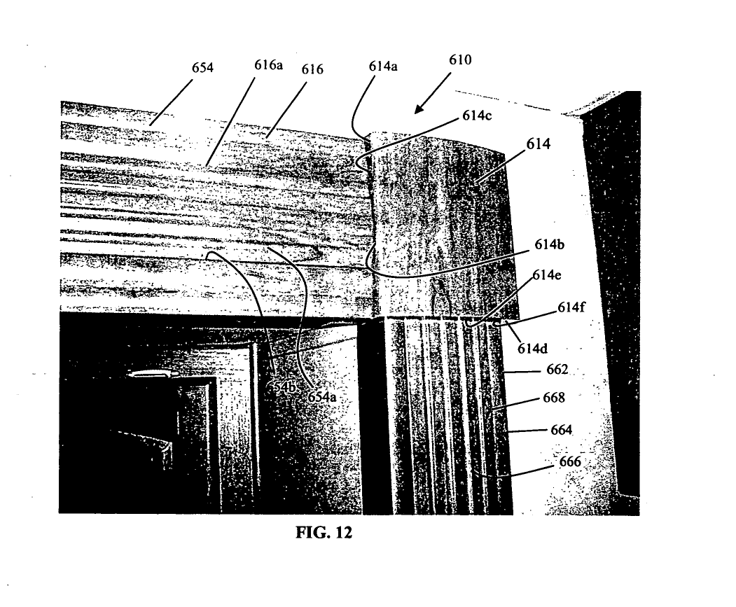

FIG. 12 is an enlarged view of another embodiment of the trim assembly of the present invention illustrating another embodiment of a right-hand corner block;

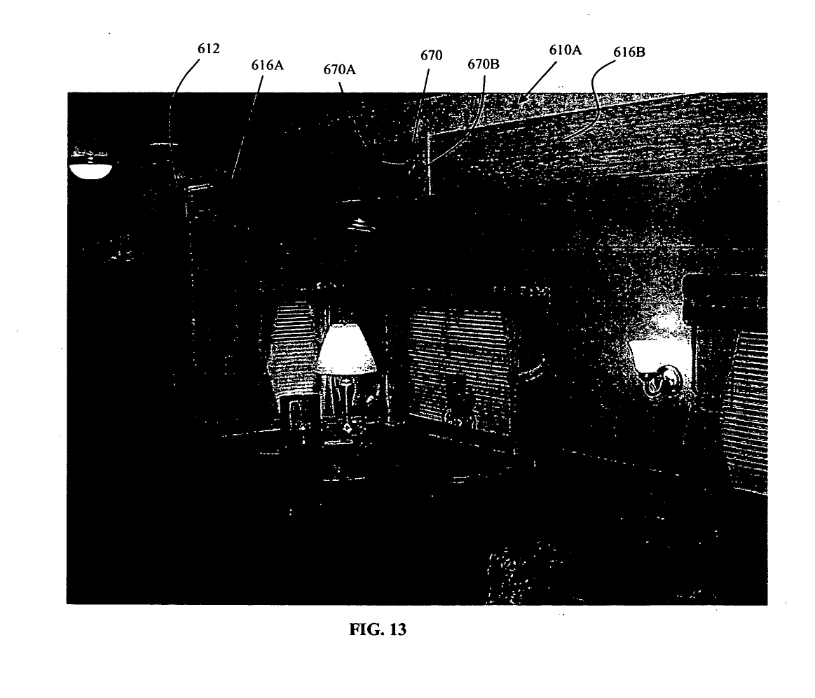

FIG. 13 is a perspective view of yet another embodiment of the trim frame assembly of the present invention;

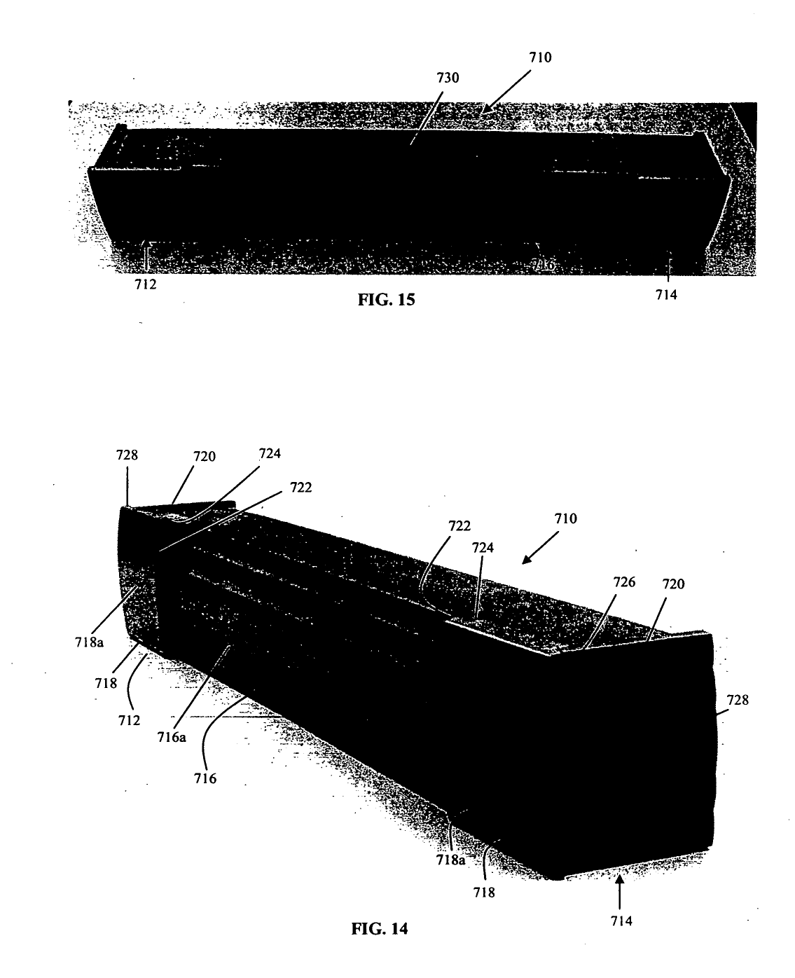

FIG. 14 is a perspective view of another trim assembly of the present invention; and

FIG. 15 is a top perspective view of the trim assembly of FIG. 14.

### DETAILED DESCRIPTION OF THE PREFERRED EMBODIMENTS

Referring to FIG. 1, the numeral 10 generally designates a trim assembly of the present invention. Trim assembly 10 is formed from a plurality of trim components that are configured to provide a simplified trim assembly that is easier to assemble and install by eliminating at least some of the precision cutting required with conventional trim work while still providing precision joinery. Further, given the modular nature of the trim components of the present invention, the trim components can be combined in numerous different ways to create customized trim work at a significantly reduced cost over conventional trim work.

In the illustrated embodiment, trim assembly 10 includes left and right corner blocks 12 and 14 and a crown trim member 16 which are assembled to form crown-molding. As will be more fully described below, trim assembly 10 may be used to trim areas in the kitchen of a recreational vehicle or may be used to trim the perimeter of a slide-out, for example. Further, as will be more fully appreciated from the description that follows, various components of the trim assembly may be combined with other components to create a simplified modular system for installing trim work.

Referring again to FIG. 1, corner blocks 12 and 14 are adapted to provide receptacles for and receive trim member 16 in the corner blocks, which facilitates the installation of the trim assembly and, further, reduces the accuracy needed for cutting trim member 16; therefore, this arrangement provides for a greater tolerance for the length of the trim member 16 when installing trim assembly 10. This greatly facilitates the installation and, further, the speed of the installation.

As best seen in FIGS. 1-3, each corner block 12, 14 is formed from a pair of end members 18, 20 and 48, 50. For ease of description, only the left-hand corner block 12 will be described in detail with the understanding that the right-hand corner block is a substantially mirror image of the left-hand corner block. Though it should be understood that the blocks need not be identical. In the illustrated embodiment, end members 18 and 20 comprise plate members with inwardly facing sides 22 and 24 and outwardly facing sides 26 and 28. In the left-hand corner block configuration, inwardly and outwardly facing sides 22, 24, and 26 are generally planar. While outwardly facing side 28, which faces the end 16a of trim member 16, includes a recess 30 to receive end 16a of trim member 16. Optionally, recess 30 includes a perimeter 32, which is shaped to generally follow the profile of the outwardly facing surface 16b of trim member 16. In this manner, when corner block 12 is mounted over the end of trim member 16, the joint will have the appearance of precision joinery. Further, recess 30 may extend from perimeter 32 to rearward edge 34 and also to upper edge 36 of end member 20, which further simplifies the installation process. For example, with this configuration, trim member 16 may be first mounted to a fixed surface, for example, a wall or other structure, and then the corner block 12 may be mounted over the end of trim member 16.

To provide a more aesthetically appealing trim assembly, preferably the lower end 30a (as viewed in FIG. 3) of recess 30 terminates before lower edge 38 of end member 20 so as to provide end member 20 with an uninterrupted substantially continuous outer surface 40 starting at the forward end of upper edge 36 and extending downwardly and rearwardly to the rearward-most edge 42 of end member 20. In this manner, when viewed from below or a normal standing position, trim assembly 10 will have all of the indicia of custom trim work.

In addition, block member 12 includes a trim member 44 mounted between end members 20 and 22. In the illustrated embodiment, trim member 44 comprises two trim pieces 46 and 47 which are joined together to form trim member 44 and extend between and are mounted to the respective end members 20 and 22. Optionally, trim member 44 may have a similar profile as trim member 16. In the illustrated embodiment, the connections between trim member 44 and end members 20 and 22 comprise butt joints; however, it may be appreciated that other types of joints or connections may be used. For example, blocks 12 and 14 may be preassembly with a standard width, so that the only variable is the length of trim member 16.

Referring again to FIG. 1, right-hand corner block 14 is similarly configured to left-hand corner block 12 with two end members 48 and 50 and a trim member 52, which extends between end members 48 and 50. Similarly, trim member 52 is formed from two trim pieces 54 and 56. However, for further details of end members 48 and 50 and trim member 52, reference is made herein to corner block 12, but with the understanding that they are mirror images. In this manner, after trim member 16 is mounted to a fixed surface, such as a wall, and corner block 12 is mounted to the fixed surface over the first end of trim member 16, block 14 may be then mounted to the fixed surface over the other end of trim member 16. It should be understood that the order of the blocks may be reversed—in other words block 14 is first mounted to the fixed surface over the end of trim member 16, and then block 12 is mounted to the fixed surface over end 16a of trim member 16. In this manner, the components of trim assembly 10 allow for a greater tolerance for the length of trim member 16 when installing trim assembly 10 and greater flexibility in the location of the corner blocks; thereby greatly reducing the time and cost to install trim assembly 10 in for example, as noted above, a recreational vehicle.

In the illustrated embodiment, end members 18, 20, 48 and 50 are four-sided plate-shaped members; however, it may be appreciated that the shape, size, and cross-section of the end members may be varied as desired depending on the shape of the trim members and also the desired appearance of the trim assembly. In addition, as will be more fully described in reference to the further embodiments described below, trim members 16, 44, and 52 may be varied to accommodate different styles and configurations. Further, additional trim members or pieces may be added to trim assembly 10. For example, the column trim members described in reference to the later embodiments may be added to trim assembly 10 to form a trim frame assembly for framing, for example an archway or an opening in a wall or, as noted above, for framing a slider in a recreational vehicle.

Referring to FIG. 4, FIG. 4 illustrates another embodiment 110 of the frame assembly of the present invention. Frame assembly 110 is similar to frame assembly 10 in that it includes a left-hand corner block 112, a right-hand corner block 114 (shown in FIG. 5) and a trim member 116, which is mounted to a fixed surface and extends between corner blocks 112 and 114. In the illustrated embodiment, corner blocks 112, 114 are assembled from end members 118, 120, 148, and 150 that include extensions 118a, 120a, 148a, and 150a to accommodate a larger trim member 116.

As best understood from FIG. 4, trim member 116 is formed from two trim pieces 154 and 156. In the illustrated embodiment, trim piece 156 includes a groove or recessed portion 158, which allows additional trim pieces to be added to trim member 116 to alter the appearance of the trim member, as will be more fully described in reference to the third embodiment. Additionally, as described in reference to the column trim members, when an insert trim piece is located in the groove 158, the insert trim piece may be used to hide mounting hardware.

In addition, in the illustrated embodiment, trim assembly 110 incorporates column trim members 160 (FIG. 4) and 162 (FIG. 5), which extend up into corner blocks 112 and 114 between end members 118, 120 and 148, 150, respectively. Further, column trim members 160 and 162 extend behind trim members 144 such that at least trim piece 147 of corner block 112 overlaps with the upper end of column 160 and trim piece 147 of corner block 114 overlaps with the upper end of column trim member 162. In addition, lower edges 147a of trim pieces 147 are optionally shaped to generally conform to the profile of column trim members 160, 162.

In the illustrated embodiment, column trim member 162 includes a base trim piece 164 and an insert trim piece 166, which is inserted into a recess 168 formed in base trim piece 164. Similarly, recess 168 permits various-shaped decorative insert trim pieces to be placed in the recess to vary the overall appearance of the trim assembly. In addition, insert trim pieces 166 may be used to hide the mounting hardware that mounts base trim piece to the fixed surface. For example, the mounting hardware for the base trim pieces may be located in recesses 168 so that when insert trim pieces are located in recesses 168, pieces 166 will cover the hardware. The insert pieces may then be mounted to base trim pieces by adhesive and/or by pin nails or screws or the like.

When installing trim assembly 110, column trim members 160 and 162 are typically mounted to the fixed surface (wall or slider, for example). Once the columns are in place, trim member 116 is then mounted so that it extends between column trim members 160 and 162. Thereafter, blocks 112 and 114 may be mounted to the fixed surface so that they cover the ends of trim member 116 and column trim members 160, 162. Alternately, trim member 116 may be mounted first, followed by the column trim members.

Referring to FIGS. 5E and 5F, the numeral 170 generally designates a splice block of the present invention. Splice block 170 is particularly useful when the span between two corner blocks is long. Splice block 170 is of similar construction to corner blocks 112 and 114 and includes end members 172, 174 and a trim member 176 mounted between the end members 172 and 174, except that its end members 172 and 174 each include on their outer facing sides a recess 178, 180, respectively, for receiving the end of a trim member.

In the illustrated embodiment, trim member 176 includes three trim pieces—an upper decorative trim piece 182, lower trim piece 184, and an intermediate trim piece 186, which comprises a return trim piece as would be understood by those skilled in the art.

To install a trim assembly with splice block 170, a first of the trim members is mounted to a fixed mounting surface, such as a slide-out or wall, and the other trim member is mounted to the fixed surface aligned and spaced from the first trim member sufficient to accommodate splice block 170. Then splice block 170 is mounted over the ends of the trim members and secured to the fixed surface. The corner blocks are then mounted over the other ends of the respective trim members, in the same manner described in reference to trim assembly 110.

As will be understood by those skilled in the art, with the overlapping and receptacle arrangement provided between the various trim members and the corner blocks, the trim assembly of the present invention may be quickly and easily installed, which significantly reduces the cost of providing decorative trim work.

Referring to FIGS. 6 and 7, FIGS. 6 and 7 illustrate a similar trim assembly to trim assembly 110; however, the various trim components are formed from a different wood or have a different wood finish.

Referring to FIG. 8, the numeral 210 designates another embodiment of the trim assembly of the present invention. Trim assembly 210 is similar to trim assembly 110 and includes a left corner block 212 and a right corner block (not shown) and a trim member 216, which extends between the left and right corner blocks. In the illustrated embodiment, trim member 216 includes trim pieces 256, 258, and 258a. Trim piece 256 includes a recess 258 into which the third trim piece (258a) is inserted to provide further detailing to trim assembly 210. As would be understood, similar to the previous embodiments, the end members of the respective corner blocks include recesses with perimeter edges that follow the profiles of trim member 216 with the added trim insert 258a.

Similarly, column trim member 260 includes a base trim member 264 and an insert trim member 266. In the illustrated embodiment, insert trim member 266 includes a fluted profile to further enhance the detail of the trim assembly 210. Optionally, trim pieces 247 of the respective corner blocks include lower edges 247a that generally follow the contour of the column trim members with the fluted insert trim piece 266. It should be understood, therefore, the present invention provides a modular system of trim components that can substituted or added to enhance the overall aesthetic appearance of the trim assembly.

Referring to FIG. 10, the numeral 310 refers to another embodiment of the trim assembly of the present invention. Trim assembly 310 may be suitable for use as crown molding between a wall and a cabinet or between cabinets or the like. As best seen in FIG. 10, trim assembly 310 includes a right-hand end member 348 and a left-hand end member (not shown but similar to end member 220 of the previous embodiment), and a trim member 316 which extends between the respective end members. For further details of the end members and trim member 316, reference is made to the previous embodiment.

Referring again to FIG. 10, the numeral 410 designates another embodiment of the trim assembly of the present invention. Trim assembly 410 forms a column trim assembly and includes a corner block 412, which is similar to corner block 212 of the previous embodiment, and a column trim member 460, which is also similar to column trim member 260 of the previous embodiment. However, in this application, end member 420 does not include a recess on its outwardly facing side and, instead, is planar similar to end member 418.

Referring to FIG. 11, the numeral 510 generally designates a sixth embodiment of the trim assembly of the present invention. Trim assembly 510 is similar to trim assembly 10 of the first embodiment but incorporates left and right column trim members 560 (right-handed column trim member not illustrated). Therefore, for further details of end members 518, 520, and trim members 512 and 516, reference is made to the first embodiment. The column trim members are of similar construction to column trim members 260, 262, with each column trim member including a base trim piece 564 and an insert trim piece 566 which is positioned in a recess 568 formed in base trim piece 564. The upper end of column trim member 560 extends between end members 518 and 520 and, further, extends behind trim member 544. In addition, the lower edge 547a of lower trim piece 547 (of trim member 544) is preferably shaped to at least generally follow the profile or contour of column trim member 560.

Referring to FIG. 12, the numeral 610 generally designates a seventh embodiment of the trim assembly of the present invention. Trim assembly 610 includes a left and right-hand corner block 614 (only right-hand corner block is shown), a trim member 616, and a column trim member 662, which extends into the lower end 614a of corner block 614. In the illustrated embodiment, the corner blocks are formed from a solid block of material with two recesses—one at its inwardly facing side and one at its lower facing side, as will be described below. Trim member 616 extends into the inwardly facing side 614a of corner block 614 and, preferably, extends into a recess 614b formed in inwardly facing side 614a and, further, into a recess 614b that includes a perimeter edge 614c that is shaped to at least generally match the profile of the outwardly facing surface 616a of trim member 616. Similarly, lower end 614d includes a recess 614e into which column trim member 662 extends and, further, that includes a perimeter edge 614f that generally follows the profile of the outwardly facing surface column 662.

In the illustrated embodiment, trim member 616 includes a base trim piece 654 and an insert trim piece 654a that is located in a recess 654b formed in trim piece 654. Again, the recess can be left unfilled or filled with yet another trim piece with a different profile to vary the appearance of the trim assembly. Similarly, column trim member 662 includes a base trim piece 664 and an insert trim piece 666, which is located in recess 668 formed in base trim piece 664. In this manner, each of the trim members may be modified with different inserts to thereby vary the aesthetic appearance of the trim assembly.

Referring to FIG. 13, the numeral 610A designates another embodiment of a trim assembly, which is of similar construction to trim assembly 610. Trim assembly 610A includes left and right corner blocks 612, 614 and two trim members 616A and 616B, which are spliced together by splice block 670. Splice block 670 is of similar construction to corner blocks 612, 614 except that it includes a recess on each of its outwardly facing sides 670A, 670B similar to splice block 170. For the remaining details of corner blocks 612, 614, and trim members 616A, 616B, reference is made to the previous embodiments.

Referring to FIGS. 14 and 15, the numeral 710 generally designates another embodiment of a trim assembly of the present invention. In the illustrated embodiment, trim assembly 710 includes a pair of corner blocks 712, 714 and a trim assembly 716 that extends between the two corner blocks.

Corner blocks 712, 714 are each formed from two plate members 718 and 720 that are joined at right angles. Plate member 718 forms the front facing side of the corner block and includes at its inwardly facing edge 722 a recess 724 for receiving the end of trim member 716. Plate member 720, which is optionally configured to have the same profile as trim member 716, is similarly received in a recess 726 formed in edge 728 to thereby form an L-shaped corner block.

Optionally, trim assembly 710 may further include a second trim member 730 and a third trim (not shown), which close the space between trim member 716 and the surface to which trim assembly 710 is mounted. For example, these additional trim members may be planar or may have a decorative profile and may similarly extend into recesses formed or provided in the inwardly facing sides of plate members 720. Further, these additional trim members may be jointed with trim member 716 to form a three-sided box that can be mounted to the mounting surface, such as the wall of an RV, and then trimmed with corner blocks 712 and 714.

As best seen in FIG. 14, recesses 724 formed in plate members 718 are optionally configured and shaped to substantially or at least generally follow the contour or contours of the outwardly facing side 716a of trim member 716.

In the illustrated embodiment, the outer facing side 718a of plate member 718 is contoured to enhance the aesthetic appearance of the trim assembly.

It should be understood that trim assembly 710 may be used to form valences around windows or may be used as a component with another trim assembly to form a modular trim system.

As will be understood from the foregoing, the trim assembly of the present invention may be formed from a variety of different trim components or pieces that allow for modular construction of the trim assembly and, further, allow for greater flexibility in the design of the trim assembly. In addition, one or more assemblies may be combined. In this manner, the present invention provides a modular trim system in which various components can be mixed and matched in a large number of different combinations without the expense and time associated with conventional trim work.

The various components of the present invention may be joined or mounted using a variety of different fastening methods, including adhesives, pin nails, screws or the like. In addition, by providing the receptacle-type connections in one or more of the joints, for example between the trim member and the end members or between the column trim member and the corner blocks, the need for precision cutting normally associated with conventional trim work is eliminated. Instead, the individual pieces may be cut using far greater tolerances, for example, on the order of a ¼ inch, ½ inch, or even more in some cases, which greatly reduces the cost of installing the trim assemblies.

While several forms of the invention have been shown and described, further modifications and changes may be made without departing from the scope of the invention. For example, the various components in the trim assemblies may be formed from solid wood components or wood-like components—for example MDF substrates covered with a wood-like sheet of paper or vinyl. Alternately, the components may be made from impregnated cellulose that creates a wood-like appearance. Further, the components may be painted and, therefore, may be formed from other materials, such as plastic or MDF or the like. In addition, one feature from one assembly may be combined with the feature of another assembly. For example, in one application, one end of the trim member may terminate at a corner block, while the other end of the trim member may terminate at an end member. In addition, any of the corner blocks may be modified as a splice block, such as described in reference to FIGS. 5E and 5F, and used to splice two or more trim members together—in which case both outwardly facing sides of the end members forming the corner block would be formed with recesses to provide receptacles for the ends of the trim members.

Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

1-20. (canceled)

21. A method of making a trim assembly comprising:
providing a first end member with a first side and a second side;
providing a trim member with first and second opposed ends and an outer facing surface having a profile;
forming a recess in said first side of said first end member, said forming including shaping a perimeter edge of the recess to generally follow the profile of the trim members;
providing a second end member with first and second sides;
forming a second recess in the first side of the second end member, said forming a second recess including shaping a perimeter of the second recess to generally follow the profile of the trim member; and
positioning the trim member in the recesses of the first and second end members to thereby form the trim assembly.

22. The method according to claim 21, wherein said providing a trim member includes providing a trim member formed from first and second trim pieces.

23. The method according to claim 22, further comprising forming a recess in the first trim piece, and placing the second trim piece in the recess of the first trim piece to thereby form the trim member.

24. The method according to claim 21, further comprising providing third and fourth end members, each of said third and fourth end members having a first side and a second side;
providing second and third trim members;
mounting the second trim member between the first end member and a third end member; and
mounting the third trim member between the second end member and the fourth end member.

25. The method according to claim 24, further comprising providing a fourth trim member;
positioning an end of the fourth trim member between the first and third end members; and
overlapping the second trim member with the fourth trim member wherein the fourth trim member extends behind the second trim member between the first and third end members.

26. The method according to claim 25, further comprising providing a fifth trim member;
positioning the fifth trim member between the second and fourth end members; and
overlapping the third trim member with an end of the fifth trim member wherein the fifth trim member extends behind the third trim member between the second and fourth end members.

27. The method according to claim 25, further comprising shaping a lower edge of the second trim member to generally follow a contour of an outer facing surface of the fourth trim member where the second trim member overlaps with the fourth trim member.

28. The method according to claim 26, further comprising shaping a lower edge of the third trim member to generally follow a profile of an outer facing surface of the fifth trim member.

29. The method according to claim 21, further comprising forming any one of the members from wood, a wood composite material, or a substrate coated with a wood-like finish.

30. A trim assembly comprising:
a first trim member, said first trim member having a first end and a second end opposed from said first end;
a first end member, said first end member having a first side facing said first end of said first trim member and a second side opposite said first side;
a second end member, said second end member having a first side facing said second end of said first trim member and a second side opposite said first side, wherein said first trim member is mounted between said first and second end members; and
wherein one of said first and second end members has a second side which includes a recess for receiving a second trim member.

31. The trim assembly according to claim 30, wherein both of said first and second end members have second sides with recesses formed therein for receiving trim members.

32. The trim assembly according to claim 31, wherein each of said members comprises a wood member.

33. A splice block for joining two elongated trim members having a predetermined outer surface and profile, said splice block comprising:
a trim member, said trim member having an outer facing surface with the same profile as the elongated trim members;
a first end member coupled to a first end of said trim member;
a second end member coupled to a second end of said trim member opposite said first end; and
wherein said end members have sides opposite said trim member which include recesses for receiving ends of said elongated trim members for splicing said elongated trim members using said splice block.

34. The splice block according to claim 33, wherein said recesses of said end members have a shape corresponding to the profile of said elongated trim members.

35. The splice block according to claim 34, wherein each of said members comprises a wood member.

36. A corner trim block assembly comprising:
a trim member, said trim member having an outer facing surface with a profile, a first end, and a second end opposed from said first end;
a first end member, said first end member having a first side facing said first end of said trim member and a second side opposite said first side, said first side having a recess formed therein for receiving said first end of said trim member, said recess having a perimeter edge having a shape generally following said profile of said trim member wherein said trim member is insertable into said recess, said second side of said first end member being substantially planar; and
a second end member, said second end member having a first side facing said second end of said trim member and a second side opposite said first side, said first side of said second end member having a recess formed therein, said recess extending into said second end member through said first side of said second end member, said recess having a perimeter edge having a shape generally following said profile of said trim member wherein said trim ember is insertable into said recess in said first side of said second end member, and wherein said second side of said second end member includes a recess shaped to receive a second trim member therein.

37. The corner trim block assembly according to claim 36, wherein said trim member comprises at least two trim pieces.

38. The corner trim block assembly according to claim 37, wherein each of said members comprises a wood member.
